(19) United States
(12) Patent Application Publication
(10) Pub. No.: US 2017/0090970 A1
(43) Pub. Date: Mar. 30, 2017

(54) METHOD, SYSTEM AND COMPUTER PROGRAM FOR CLOUD BASED COMPUTING CLUSTERS FOR SIMULATED OPERATOR TRAINING SYSTEMS

(71) Applicant: YOKOGAWA ELECTRIC CORPORATION, Tokyo (JP)

(72) Inventors: Jothi BASKARAN, Bangalore (IN); Harsha RAHUL, Bangalore (IN); Periaswamy SUBRAMANIAN, Bangalore (IN)

(73) Assignee: YOKOGAWA ELECTRIC CORPORATION, Tokyo (JP)

(21) Appl. No.: 15/182,690

(22) Filed: Jun. 15, 2016

(30) Foreign Application Priority Data
Sep. 30, 2015 (IN) 3130/DEL/2015

(51) Int. Cl. G06F 9/455; H04L 12/911; H04L 29/08

(52) U.S. Cl. CPC G06F 9/45558; H04L 67/10; H04L 47/829; G06F 2009/45595; G06F 2009/45583

(57) ABSTRACT

The present invention provides methods, systems and computer programs for implementing a simulation based operator training system on a cloud computing cluster. The invention receives information identifying one or more parameters of an operator training simulation, and retrieves virtual machine (VM) images corresponding to a master VM, operator VM and instructor VM. The invention selects a first physical host platform, a second physical host platform and a third physical host platform and instantiates a master VM at the first physical host platform, an operator VM at the second physical host platform and an instructor VM at the third physical host platform. Network connections between the instantiated master VM, operator VM and instructor VM are thereafter configured.

### FIELD OF THE INVENTION

The present invention relates to provisioning and configuring computing clusters. In particular, the invention provides methods, systems and computer programs for optimally provisioned and configured cloud based computing clusters for computer-implemented simulation based operator training systems.

### BACKGROUND

Implementing industrial automation systems involves training of operators or other personnel to monitor and respond to situations when an industrial plant is operating within or outside of design conditions. Operator training systems achieve this by training operators or plant personnel to handle routine operations, critical operations, and/or crisis situations within a simulated environment.

FIGS. 1A and 1B illustrate exemplary computer based simulation environments for implementing operator training systems.

In FIG. 1A, the simulation environment is implemented using a first terminal 102 that functions as an operator terminal and a second terminal 104 that functions as an instructor terminal. Each of operator terminal 102 and instructor terminal 104 run software that enables an operator and an instructor to respectively view one or more simulations of a plant environment. Software on instructor terminal 104 enables instructors to create simulation scenarios for operator training, monitor ongoing simulations, and initiate events, faults, critical operating conditions or error conditions that may be presented to an operator within a simulation. Software on operator terminal 102 enables operators to view and interact with simulation scenarios for operator training, including by responding to events, faults, critical operating conditions or error conditions that are presented within a simulation. Operator terminal 102 and instructor terminal 104 may be configured to be in direct or indirect network communication with each other.

In FIG. 1B, the simulation environment of FIG. 1A additionally includes a simulation server 106. In the illustrated embodiment, simulation server 106 is responsible for running a simulation engine, while operator terminal 102 and instructor terminal 104 function as client terminals that are respectively accessed by the operator and instructor. The operator terminal 102 and instructor terminal 104 illustrated in FIG. 1B may be in direct communication with each other, or may communicate indirectly through simulation server 106.

Implementing of simulator based operator training systems of the type described above requires dedicated hardware and network configurations which are expensive to purchase, acquire and scale up. Additionally, in view of time-varying requirements for operator training systems, organizations are forced to choose between (i) over provisioning i.e. building and maintaining hardware and network capacity based on an estimated maximum resource demand (which is routinely underutilized) or (ii) under provisioning i.e. building and maintaining capacity based on an estimated average resource demand (in which case, the systems are often unable to respond to demands for higher resource capacity).

While prior art solutions for cloud based operator training systems are known such systems facing over provisioning and under provisioning issues as well.

There is accordingly a need for optimized provisioning and configuring of cloud based computing clusters for dynamically implementing simulated operator training systems.

### SUMMARY

The present invention provides a method for implementing a simulation based operator training system on a cloud based computing cluster. The method comprises the steps of: (i) receiving information identifying one or more parameters of an operator training simulation, (ii) retrieving virtual machine (VM) images corresponding to each of a master VM, an operator VM and an instructor VM, (iii) selecting from among a set of available cloud computing resources: (a) a first physical host platform for instantiation of a master VM, (b) a second physical host platform for instantiation of an operator VM, and (c) a third physical host platform for instantiation of an instructor VM, (iv) instantiating: (d) at the first physical host platform, a master VM based on a retrieved master VM image, (e) at the second physical host platform, an operator VM based on a retrieved operator VM image, and (f) at the third physical host platform, an instructor VM based on a retrieved instructor VM image, and (v) configuring network connections between the instantiated master VM, operator VM and instructor VM.

Selection of the first physical host platform from among the set of available cloud computing resources may be based on one or more of (i) number of tags (Tₙᵤₘ) implemented within an identified operator training simulation, (ii) a specified number of instances (Simₙᵤₘ) of the identified operator training simulation for parallel execution at the master VM, (iii) a specified time scale (T_{scale}) for performance of the identified operator training simulation, and (iv) a specified division of basic cycle (BasCycleᵥₐₗ) for performance of the identified operator training simulation.

The first physical host platform selected for instantiation of the master VM may comprise random-access memory (RAM) equal to or greater than Mem_{RAM}, wherein Mem_{RAM} is determined based on constraint (1):

Mem_{RAM} (in gigabytes)=4+[CEIL(Tₙᵤₘ/10,000)+CEIL(Tₙᵤₘ/10,000)MOD 2)]×Simₙᵤₘ (Constraint 1).

For the purposes of this embodiment, CEIL is a function that increments a calculated real number to the smallest integer that is not less than the calculated real number, and MOD is a function that returns a remainder after Euclidean division of one number by another number.

The first physical host platform selected for instantiation of the master VM may comprise data storage capacity equal to or greater than Memₛₜₒᵣₑ, wherein Memₛₜₒᵣₑ is determined based on constraint (2):

Memₛₜₒᵣₑ (in gigabytes)=50+[CEIL(T/10,000)]×20 (Constraint 2)

For the purposes of this embodiment, CEIL is a function that increments a calculated real number to the smallest integer that is not less than the calculated real number.

In an embodiment of the method, the first physical host platform selected for instantiation of the master VM may comprises a number of processors equal to or greater than Processorₙᵤₘ, wherein Processorₙᵤₘ. is determined based on one or more of constraints (3) to (8):

where the time scale T_{scale} specifies acceleration of less than 32 times a default time scale

for the identified operator training simulation, Processorₙᵤₘ2 (Constraint 3)

where the time scale T_{scale} specifies acceleration of 32 times or more, but less than 64 times the default time scale for the identified operator training simulation, Processorₙᵤₘ≧4 (Constraint 4)

where the time scale T_{scale} specifies acceleration of 64 times or more over the default time scale for the identified operator training simulation, Processorₙᵤₘ≧8 (Constraint 5)

where the division of basic cycle value BasCycleᵥₐₗ is 1, Processorₙᵤₘ≧2 (Constraint 6)

where the division of basic cycle value BasCycleᵥₐₗ is 2, Processorₙᵤₘ≧4 (Constraint 7)

where the division of basic cycle value BasCycleᵥₐₗ is 4, Processorₙᵤₘ≧8 (Constraint 8).

In an embodiment of the method, at least one processor within the first physical host platform selected for instantiation of the master VM has a clock speed greater than or equal to 2.0 GHz.

In another embodiment, either or both of the second and third physical host platforms may comprise one or more of:
a processor having a clock speed greater than or equal to 2.0 GHZ,
at least 4 gigabytes of RAM, and
data storage capacity of at least 50 gigabytes.

The invention additionally provides a system for implementing a simulation based operator training system on a cloud based computing cluster. The system comprises (i) an interface for receiving information identifying one or more parameters of an operator training simulation, (ii) a repository of virtual machine (VM) images comprising at least a master VM image, an operator VM image and an instructor VM image, (iii) a master VM instantiated on a first physical host platform selected from among a set of available cloud computing resources, wherein instantiation of the master VM is based on the master VM image, (iv) an operator VM instantiated on a second physical host platform selected from among the set of available cloud computing resources, wherein instantiation of the operator VM is based on the operator VM image, and (v) an instructor VM instantiated on a third physical host platform selected from among the set of available cloud computing resources, wherein instantiation of the instructor VM is based on the instructor VM image.

The instantiated master VM and the instantiated operator VM may be in network communication with each other, and the instantiated master VM and the instantiated instructor VM are in network communication with each other. Additionally, selection of the first physical host platform from among the set of available cloud computing resources may be based on one or more of: (i) number of tags (Tₙᵤₘ) implemented within an identified operator training simulation, (ii) a specified number of instances (Simₙᵤₘ) of the identified operator training simulation for parallel execution at the master VM, (iii) a specified time scale (T_{scale}) for performance of the identified operator training simulation, and (iv) a specified division of basic cycle (BasCycleᵥₐₗ) for performance of the identified operator training simulation.

In a system embodiment, the first physical host platform comprises random-access memory (RAM) equal to or greater than Mem_{RAM}, wherein Mem_{RAM} is determined based on constraint (1):

Mem_{RAM} (in gigabytes)=4+[CEIL(Tₙᵤₘ/10,000)+CEIL(Tₙᵤₘ/10,000)MOD 2)]×Simₙᵤₘ (Constraint 1).

In said embodiment, CEIL is a function that increments a calculated real number to the smallest integer that is not less than the calculated real number, and MOD is a function that returns a remainder after Euclidean division of one number by another number.

The first physical host platform may comprise data storage capacity equal to or greater than Memₛₜₒᵣₑ, wherein Memₛₜₒᵣₑ is determined based on constraint (2):

Memₛₜₒᵣₑ (in gigabytes)=50+[CEIL(Tₙᵤₘ/10,000)]×20 (Constraint 2).

In said embodiment, CEIL is a function that increments a calculated real number to the smallest integer that is not less than the calculated real number.

In another system embodiment, the first physical host platform comprises a number of processors equal to or greater than Processorₙᵤₘ, wherein Processorₙᵤₘ is determined based on one or more of constraints (3) to (8):

where the time scale T_{scale} specifies acceleration of less than 32 times a default time scale for the identified operator training simulation, Processorₙᵤₘ≧2; (Constraint 3)

where the time scale T_{scale} specifies acceleration of 32 times or more, but less than 64 times the default time scale for the identified operator training simulation, Processorₙᵤₘ≧4; (Constraint 4)

where the time scale T_{scale} specifies acceleration of 64 times or more over the default time scale for the identified operator training simulation, Processorₙᵤₘ≧8; (Constraint 5)

where the division of basic cycle value BasCycleᵥₐₗ is 1, Processorₙᵤₘ≧2; (Constraint 6)

where the division of basic cycle value BasCycleᵥₐₗ is 2, Processorₙᵤₘ≧4; (Constraint 7)

where the division of basic cycle value BasCycleᵥₐₗ is 4, Processorₙᵤₘ≧8; (Constraint 8).

At least one processor within the first physical host platform may have a clock speed greater than or equal to 2.0 GHz. In an embodiment of the system, either or both of the second and third physical host platforms comprises one or more of a processor having a clock speed greater than or equal to 2.0 GHZ, at least 4 gigabytes of RAM, and data storage capacity of at least 50 gigabytes.

The invention additionally provides a computer program product for implementing a simulation based operator training system on a cloud based computing cluster, comprising a non-transitory computer usable medium having a computer readable program instructions for implementing the method steps of the present invention.

### BRIEF DESCRIPTION OF THE ACCOMPANYING DRAWINGS

FIGS. 1A and 1B illustrate exemplary computer based simulation environments for implementing operator training systems.

FIGS. 2 and 3 illustrate cloud based computing clusters.

FIG. 4 illustrates a method of instantiating a cloud computing cluster.

FIG. 5 illustrates an exemplary computing system for implementing the present invention.

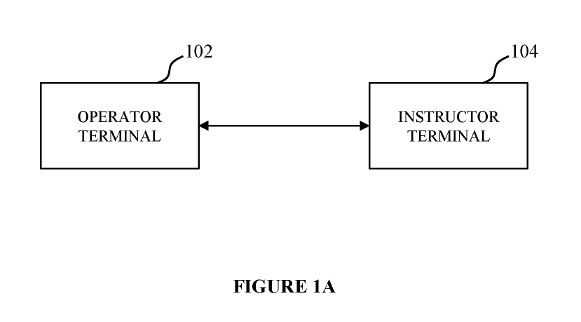

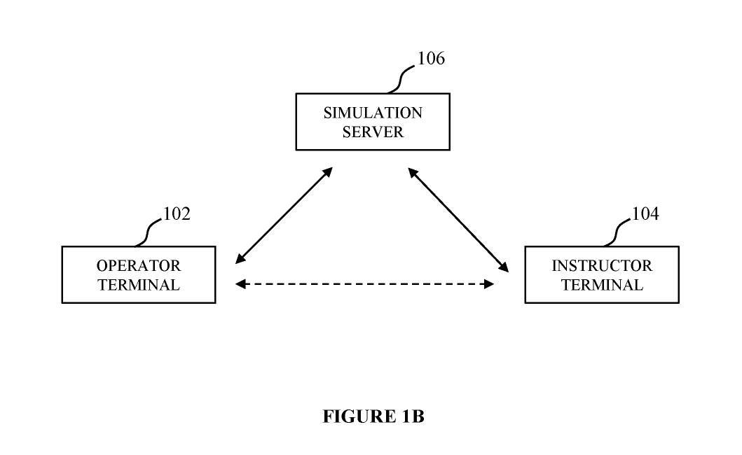

### DETAILED DESCRIPTION

For the purposes of the invention, “available cloud resource(s)” or “available cloud computing resources” shall mean the set of hardware, software and network resources within the cloud that are available for allocation or reservation in response to a request for provisioning of cloud resources.

For the purposes of the invention, “basic cycle” shall mean an interval of time defined in connection with a software application, which interval separates execution of two consecutive instructions corresponding to the software application. For example, if the basic cycle for an application is 1 second, instructions for an execution command corresponding to the software application shall be sent once every second.

For the purposes of the invention, “change in time scale” or “changing the default time scale” or “specifying a time scale” refers to implementing a variation in the time required for completion of performance of a simulation. For example, if in the ordinary course, performance of a simulation would involve a fixed period of time, changing the default time scale by way of acceleration can reduce the duration required for completion of simulation performance, while changing the time scale by way of deceleration can increase the duration required for completion of simulation performance.

For the purposes of the invention, “divide basic cycle”, “division of basic cycle” or “dividing basic cycle” shall mean redefining the basic cycle as a fraction of the default basic cycle. For example, a “divide basic cycle” value of 1 means that the cycle is not divided and that the default basic cycle remains unchanged. In another example, if the basic cycle is 1 second and the specified “divide basic cycle” value is 4, instructions for an execution command will be sent 4 times per second in connection with the concerned application. Division of basic cycle can be used to execute certain applications that require high speed control operations, without increasing the computational load of other applications.

For the purposes of the invention, “function block” shall mean a discrete or self-contained block comprising code that defines and implements an input function (an input function block) an output function (an output function block), or a control function (a control function block) associated with a field device or any other part of a control system. A function block may include any discrete data point (analog or digital) that the control system may need to display or control and represents, on the basis of corresponding algorithms which are executed in a processor or microprocessor, functions that are intended to be implemented or executed using or more device or hardware components (such as controllers, actuators, sensors or other field devices) within a control system. Exemplary function blocks may include without limitation, components, component inputs, component outputs, set points, system or process variables, controller gains, module status, calculation variables, logical actions, sequential operations, interlocks control blocks, one or more specific wiring points on a digital or analog input or output card, logic charts, logic blocks, calculation blocks or data inputs to our data outputs from a logic or calculation block.

For the purposes of the invention “physical host platform” shall mean a physical computer system comprising one or more processors or processing units, a random access memory, a network interface and/or data storage. A physical host platform in accordance with the present invention may implement any of a number of system architectures, including without limitation the ×86 architecture.

For the purposes of the invention, “simulation engine” shall mean a platform, device or set of instructions for executing a simulation model in accordance with a set of defined initial values and one or more input variable values, to provide simulated output variable values.

For the purposes of the invention, “simulation model” shall mean a mathematical representation of relationships or dynamics between input and output parameters, and of transition states of the simulated environment.

For the purposes of the invention, “tag(s)” shall be understood as one or more unique identifiers that are associated with or that can be used to access a particular function block. In control systems such as DCS or SCADA, a tag comprises a unique name, variable or a memory address which may be used to access or control a component or function block to which the tag has been assigned.

For the purposes of the invention “virtual machine” or “VM” shall mean a software abstraction of a physical computer system. Each VM represents structure of a physical computer and may include both virtual system hardware and guest system software. Virtual system hardware may include at least one virtual CPU, virtual memory, at least one storage device such as a virtual disk, and one or more virtual devices. Virtual hardware components of the VM may be implemented in software to emulate corresponding physical components. The guest system software may include a guest operating system, application programs and drivers as needed.

For the purposes of the present invention, creation of a cloud based computing cluster involves configuring and deploying a cluster of virtual machines on a corresponding cluster of physical host platforms selected from within a set of available physical host platforms within the cloud.

The properties and functionality of each virtual machine (VM) may be defined by a corresponding virtual machine image (VM image) which VM image comprises one or more data files that store information, including one or more of an operating system, drivers, parameter information corresponding to the VM, and one or more application programs that may be required to start up and operate on the virtual machine when instantiated on a corresponding physical host platform. VM images may be pre-configured and/or pre-stored for the purposes of provisioning corresponding VMs.

Instantiation of a VM on a corresponding physical host platform comprises deployment of one or more of an operating system, drivers, and one or more application programs from a VM image onto the physical host platform, and thereafter executing or running the VM as an emulated machine, using the underlying physical host platform.

In provisioning a cloud based computing cluster, a single VM image may be used to provision and instantiate multiple VMs within the cluster. Alternatively, provisioning the cloud based cluster may involve selection of a plurality of pre-configured VM images from a set of pre-configured VM images, whereinafter each of the selected VM images may be used to provision and configure one or more VMs within the cluster.

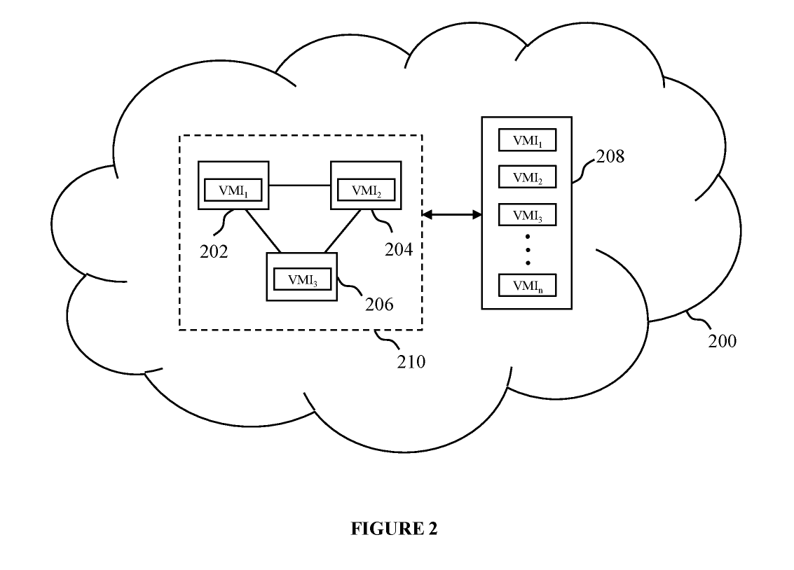

FIG. 2 illustrates an example of a cloud based computing cluster provisioned using VMs based on multiple VM images. Cloud 200 comprises VM image repository 208, which in turn includes multiple VM images—VMI₁ to VMₙ. Cloud based computing cluster 210 comprises first, second and third VMs (202, 204 and 206) configured to interconnect in a ring topology. First VM 202 has been provisioned and configured based on VM image VMI₁, second VM 204 has been provisioned and configured based on VM image VM₂, while third VM 206 has been provisioned and configured based on VMI₃—each of which VM images have been selected and retrieved from VM image repository 208. The configuration and characteristics of each VM within cluster 210 is based on information within the corresponding VM image. While not specifically illustrated in FIG. 2, it would be understood that each VM within cluster 210 is implemented on a corresponding physical host platform within cloud 200. For optimal performance, the properties and characteristics of each physical host platform identified or selected to host a corresponding VM should correspond to the properties and requirements of such VM and the selection step may therefore be premised on one or both of (i) information within the corresponding VM image and (ii) information received from a user, device or software application requesting creation of a cloud based computing cluster or requesting provisioning of cloud computing resources.

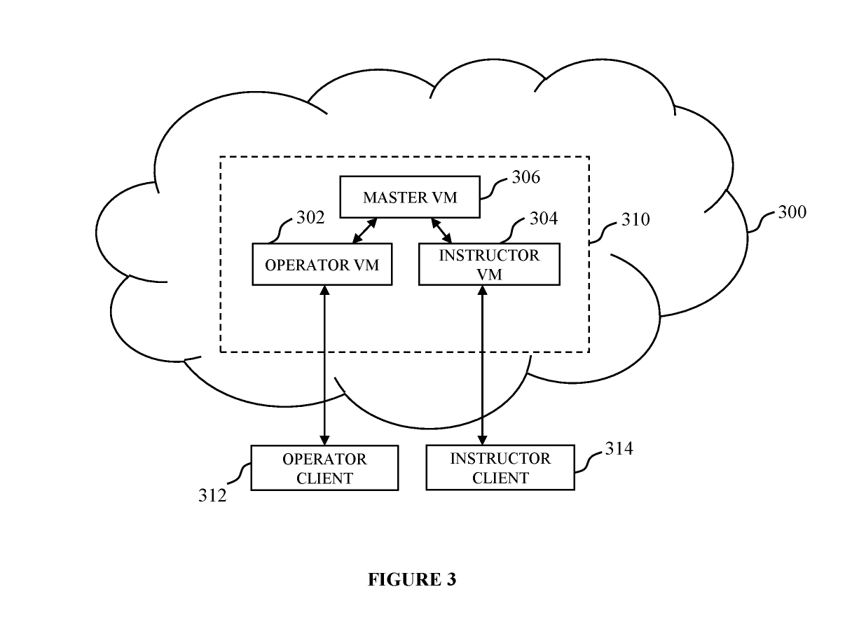

FIG. 3 illustrates a cloud computing based operator training system implemented in accordance with an embodiment of the present invention. Cloud based computing cluster 310 is provisioned from computing resources available within cloud 300, and comprises operator VM 302, instructor VM 304 and master VM 306.

Master VM 306 comprises a virtual machine configured to execute one or more simulation engines. A simulation engine implemented within a master VM may be used to generate one or more possible scenarios within a particular simulated environment.

In an embodiment, master VM 306 may be implemented on a physical host platform within cloud 300 based on a master VM image retrieved from a VM image repository (not shown in FIG. 3).

Operator VM 302 comprises a virtual machine having operator-end software installed therein. The operator VM 302 is configured to receive data from a simulation engine under execution within master VM 306. Based on the data received from the simulation engine, operator-end software installed in operator VM 302 generates simulation output information for presentation to an operator using the simulation. It would be understood that simulation output information presented to the operator in the course of the simulation may include text, data, graphics, interface information or a combination of any two or more. The generated simulation output information may thereafter be transmitted to an operator client terminal 312 that is used by an operator for the purpose of accessing the cloud based simulation. Likewise, simulation input information corresponding to inputs provided by the operator at operator client terminal 312 may be transmitted to operator VM 302. The operator-end software may translate such simulation input information into relevant simulation data and transmit such simulation data to the simulation engine within master VM 306.

Instructor VM 304 comprises a virtual machine having instructor-end software installed therein. The instructor VM 304 is configured to receive data from a simulation engine under execution within master VM 306. Based on the data received from the simulation engine, instructor-end software installed in instructor VM 304 generates simulation output information for presentation to an instructor using the simulation. It would be understood that simulation output information presented to the instructor in the course of the simulation may include text, data, graphics, interface information or a combination of any two or more. The generated simulation output information may thereafter be transmitted to an instructor client terminal 314 that is used by the instructor for the purpose of accessing the cloud based simulation. Likewise, simulation input information corresponding to inputs provided by the instructor at instructor client terminal 314 may be transmitted to instructor VM 304. The instructor-end software may translate such simulation input information into relevant simulation data and thereafter transmit such simulation data to the simulation engine within master VM 306.

In an embodiment of the invention, (i) the simulation engine within master VM 306 is responsible for generating and modifying simulation state data based on operator and instructor input and output parameters, and based on transition states of the simulated environment, (ii) the operator-end software within operator VM 302 is responsible for translation of data received from the simulation engine into meaningful information capable of being presented to and interpreted by the operator, and translation of input data received from the operator into meaningful information capable of being transmitted to and interpreted by the simulation engine and/or (iii) the instructor-end software within instructor VM 304 is responsible for translation of data received from the simulation engine into meaningful information capable of being presented to and interpreted by the instructor, and translation of input data received from the instructor into meaningful information capable of being transmitted to and interpreted by the simulation engine.

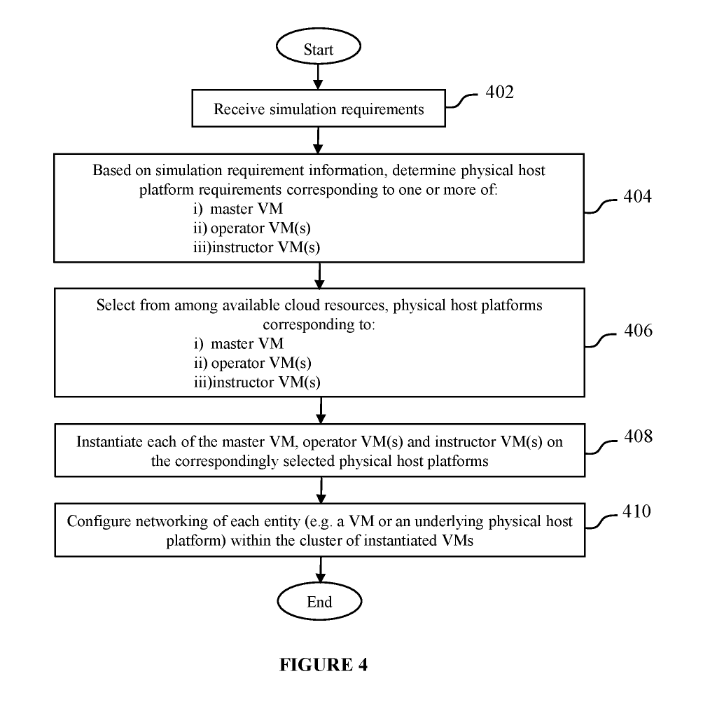

FIG. 4 illustrates a method of instantiating a cloud computing cluster configured in accordance with the teachings of the present invention, for the purposes of implementing operator training simulations.

Step 402 comprises receiving simulation requirements. The simulation requirements received at step 402 comprise parameters that define the operator training simulation intended for implementation, and may include one or more of simulation type identification, simulation engine identification, number of instances of the simulation intended for execution, number of operators participating in the simulation, number of instructors participating in the simulation, operator or instructor permissions for the purposes of the simulation, software licensing information, information corresponding to network connections between virtual machines, number of tags associated with the simulation (or with any part thereof), required time scale, required division of basic cycle, and location or access information corresponding to one or more licensing server. One or more of the simulation requirements may in an embodiment be received at an interface configured for receiving such requirements (for example at a graphical user interface).

One or more of the simulation requirements may be received by way of operator input, instructor input or any other user input, or may be generated by an automated system in response to an instruction for instantiation of the simulation, or may be retrieved from a database that stores simulations and simulation parameter data.

Based on information derived from simulation requirements received at step 402, step 404 determines minimum hardware and configuration requirements for one or more physical host platforms capable of implementing instances of a master VM, operator VM(s) and instructor VM(s) for the purpose of executing one or more simulation(s) in accordance with the simulation requirements.

Based on the minimum hardware and configuration requirements determined at step 404, step 406 selects from among the set of available cloud resources, physical host platforms respectively capable of implementing instances of a master VM, operator VM(s) and instructor VM(s) for the purpose of executing one or more simulation(s) in accordance with the simulation requirements.

Step 408 comprises instantiating the master VM and each of the operator VM(s) and instructor VM(s) on the corresponding physical host platforms selected at step 406.

Step 410 thereafter comprises configuring the networking of each VM (or the underlying physical host platform corresponding to each VM) within the cluster of VMs that have been instantiated at step 408. Network configuration at step 410 may include configuring networking of one or more of the VMs with each other, with client terminals outside the cluster, and/or with any licensing servers within or outside the cloud which contain licensing information or licensing permissions necessary for execution of any software on any VM.

In an embodiment of the method described in FIG. 4, the step 404 determination of minimum hardware requirements for selection of a physical host platform for instantiation of a master VM is based on data corresponding to one or more of:
Number of tags (Tₙᵤₘ) corresponding to or implemented within a simulation or simulation engine sought to be executed at the master VM
Number of instances (Simₙᵤₘ) of the simulation or simulation engine sought to be executed in parallel at the master VM
A time scale (T_{scale}) specified for execution of the simulation or simulation engine sought to be implemented at the master VM
A division of basic cycle value (BasCycleᵥₐₗ) that is specified for executing the simulation or simulation engine sought to be implemented at the master VM

In an embodiment, the physical host platform selected for instantiation of the master VM has random-access memory (RAM) equal to or greater than Mem_{RAM}, wherein Mem_{RAM} is a minimum RAM capacity determined based on the following constraint:

Mem_{RAM} (in gigabytes)=4+[CEIL(Tₙᵤₘ/10,000)+CEIL(Tₙᵤₘ/10,000) MOD 2)]×Simₙᵤₘ (Constraint 1)

wherein (i) CEIL is a ceiling function or ceiling operation, which increments a calculated real number to the smallest integer that is not less than the calculated real number and (ii) MOD is a modulo function or modulo operation, which returns a remainder after Euclidean division of one number by another number.

In a specific embodiment of the invention, Mem_{RAM} is greater than or equal to 4 gigabytes (GB).

In an embodiment, the physical host platform selected for instantiation of the master VM has data storage capacity (e.g. hard disk capacity) equal to or greater than Memₛₜₒᵣₑ, wherein Memₛₜₒᵣₑ is determined based on the following constraint:

Memₛₜₒᵣₑ (in gigabytes)=50+[CEIL(Tₙᵤₘ/10,000)]×20 (Constraint 2)

wherein CEIL is a ceiling function or ceiling operation, which increments a calculated real number to the smallest integer that is not less than the calculated real number.

In a specific embodiment of the invention, Memₛₜₒᵣₑ is greater than or equal to 50 GB.

In an embodiment of the invention, the minimum required number of processors (Processorₙᵤₘ) implemented within a physical host platform selected for instantiation of the master VM is based on one or both of a specified time scale (T_{scale}) and a specified division of basic cycle value (BasCycleᵥₐₗ). Specific constraints for determining Processorₙᵤₘ include:

if the specified time scale T_{scale} requires acceleration of less than 32 times the default time scale for an intended simulation, then Processorₙᵤₘ≧2 (Constraint 3)

if the specified time scale T_{scale} requires acceleration of 32 times or more, but less than 64 times the default time scale for an intended simulation, then Processorₙᵤₘ≧4 (Constraint 4)

if the specified time scale T_{scale} requires acceleration of 64 times or more over the default time scale for an intended simulation, then Processorₙᵤₘ≧8 (Constraint 5)

if the specified division of basic cycle value BasCycleᵥₐₗ is 1, Processorₙᵤₘ≧2 (Constraint 6)

if the specified division of basic cycle value BasCycleᵥₐₗ is 2, Processorₙᵤₘ≧4 (Constraint 7)

if the specified division of basic cycle value BasCycleᵥₐₗ is 4, Processorₙᵤₘ8 (Constraint 8)

For the purposes of the present invention, a physical host platform may satisfy the minimum processor requirement Processorₙᵤₘ, by way of an equivalent number of single core processors or by way of one or more multi-core processors having the minimum number of processor cores. For example, if Processorₙᵤₘ=4, a physical host platform selected in accordance with the above constraints may either have four single core processors, or a single quad-core processor, or two dual core processors. In an embodiment of the invention, at least one (and preferably each) processor within the physical host platform selected for instantiation of the master VM has a clock speed greater than or equal to 2.0 GHz. In a preferred embodiment, at least one (and preferably each) processor within the physical host platform selected for instantiation of the master VM has a clock speed greater than or equal to 2.5 GHz.

In an embodiment of the method described in FIG. 4, the step 406 selection of a physical host platform capable of supporting instantiation of an operator VM or an instructor VM, comprises selection of a physical host platform having at least one processor, 4 gigabytes of RAM and a data storage capacity of at least 50 gigabytes. The at least one processor may have a clock speed greater than or equal to 2.0 GHZ. In a more specific embodiment, the at least one processor of selected physical host platform for implementing the operator VM or the instructor VM has a clock speed greater than or equal to 2.5 GHz.

The present invention offers a multitude of advantages over known systems and methods for implementing simulation based operator training systems. In the first instance, provisioning the operator training system using cloud resources provides organizations with the necessary flexibility to dynamically scale training resources up or down without commensurate investments associated with purchase and maintenance of the necessary hardware resources. Additionally, by provisioning the cloud based cluster in accordance with one or more of the above constraints, the invention ensures that the cloud computing cluster has the minimum hardware capabilities necessary for responding to a specified training requirement thereby ensuring that implemented emulations are performed in a manner consistent with the specified performance requirements, and avoiding under provisioning type problems. Likewise, by acquiring only the minimum resources mandated by the specified constraints, the invention avoids over provisioning and the wasted costs associated therewith. The ability to flexibly select an optimally configured computing cluster in response to a specific training need also ensures that organizations only pay for computing resources on an “as-needed” basis, thereby preserving financial resources.

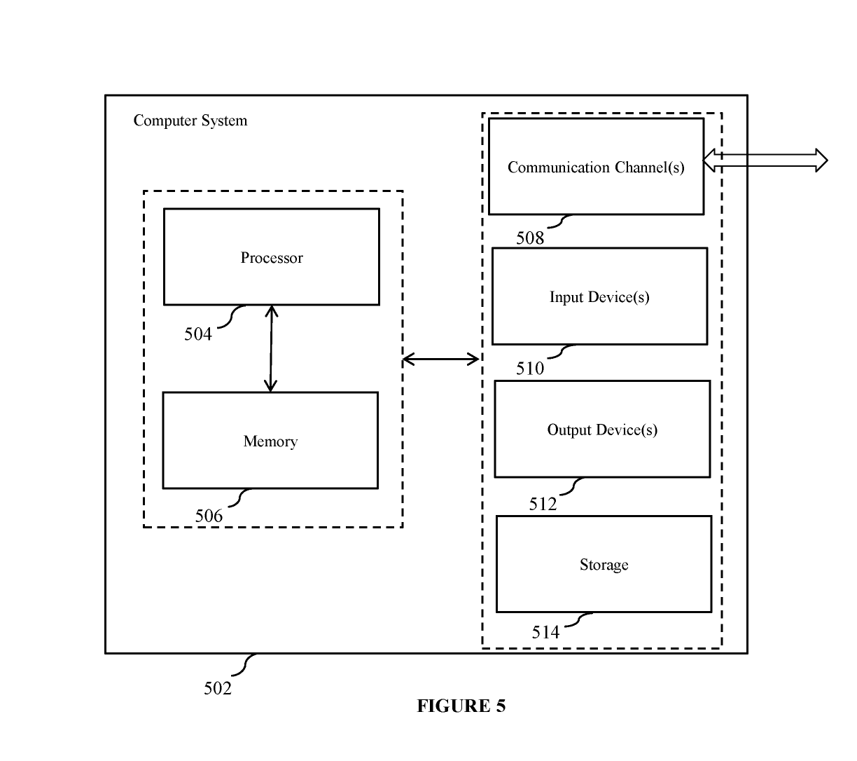

FIG. 5 illustrates an exemplary computing system which may comprise a physical host platform selected for the purposes of the present invention, from among available cloud resources.

The system 502 comprises at-least one processor 504 and at-least one memory 506. The processor 504 executes program instructions and may be a real processor. The processor 504 may also be a virtual processor. The computer system 502 is not intended to suggest any limitation as to scope of use or functionality of described embodiments. For example, the computer system 502 may include, but not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a system 502 in accordance with the present invention may include one or more servers, desktops, laptops, tablets, smart phones, mobile phones, mobile communication devices, tablets, phablets and personal digital assistants. In an embodiment of the present invention, the memory 506 may store software for implementing various embodiments of the present invention. The computer system 502 may have additional components. For example, the computer system 502 includes one or more communication channels 508, one or more input devices 510, one or more output devices 512, and storage 514. An interconnection mechanism (not shown) such as a bus, controller, or network, interconnects the components of the computer system 502. In various embodiments of the present invention, operating system software (not shown) provides an operating environment for various softwares executing in the computer system 502 using a processor 504, and manages different functionalities of the components of the computer system 502.

The communication channel(s) 508 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 510 may include, but is not limited to, a touch screen, a keyboard, mouse, pen, joystick, trackball, a voice device, a scanning device, or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 502.

The storage 514 may include, but not limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 502. In various embodiments of the present invention, the storage 514 may contain program instructions for implementing any of the described embodiments.

In an embodiment of the present invention, the computer system 502 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

It will be understood that methods, systems and computer program products in accordance with the present invention provide an optimized solution for provisioning and configuring cloud based computing clusters for the purposes of implementing simulation based operating training systems. Cloud based computing clusters provisioned in accordance with the teachings of the invention achieve dynamic, flexible, cost effective and high efficiency performance in connection with implemented computer based operator training systems, while avoiding the risks of over provisioning or under provisioning.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for implementing a simulation based operator training system on a cloud based computing cluster, the method comprising the steps of:
receiving information identifying one or more parameters of an operator training simulation;
retrieving virtual machine (VM) images corresponding to each of a master VM, an operator VM and an instructor VM;
selecting from among a set of available cloud computing resources:
a first physical host platform for instantiation of a master VM;
a second physical host platform for instantiation of an operator VM; and
a third physical host platform for instantiation of an instructor VM;
instantiating:
at the first physical host platform, a master VM based on a retrieved master VM image;
at the second physical host platform, an operator VM based on a retrieved operator VM image; and
at the third physical host platform, an instructor VM based on a retrieved instructor VM image; and
configuring network connections between the instantiated master VM, operator VM and instructor VM;
wherein selection of the first physical host platform from among the set of available cloud computing resources is based on one or more of:
number of tags (Tₙᵤₘ) implemented within an identified operator training simulation;
a specified number of instances (Simₙᵤₘ) of the identified operator training simulation for parallel execution at the master VM;
a specified time scale (T_{scale}) for performance of the identified operator training simulation; and
a specified division of basic cycle (BasCycleᵥₐₗ) for performance of the identified operator training simulation.

2. The method as claimed in claim 1, wherein the first physical host platform selected for instantiation of the master VM comprises random-access memory (RAM) equal to or greater than Mem_{RAM}, wherein Mem_{RAM} is determined based on constraint (1):
Mem_{RAM} (in gigabytes)=4+[CEIL(Tₙᵤₘ/10,000)+CEIL(Tₙᵤₘ/10,000) MOD 2)]×Simₙᵤₘ (Constraint 1)
wherein CEIL is a function that increments a calculated real number to the smallest integer that is not less than the calculated real number;
and wherein MOD is a function that returns a remainder after Euclidean division of one number by another number.

3. The method as claimed in claim 1, wherein the first physical host platform selected for instantiation of the master VM comprises data storage capacity equal to or greater than Memₛₜₒᵣₑ, wherein Mem_{store is} determined based on constraint (2):
Memₛₜₒᵣₑ (in gigabytes)=50+[CEIL(Tₙᵤₘ/10,000)]×20 (Constraint 2)
wherein CEIL is a function that increments a calculated real number to the smallest integer that is not less than the calculated real number.

4. The method as claimed in claim 1, wherein the first physical host platform selected for instantiation of the master VM comprises a number of processors equal to or greater than Processorₙᵤₘ, wherein Processorₙᵤₘ, is determined based on one or more of constraints (3) to (8):
where the time scale T_{scale} specifies acceleration of less than 32 times a default time scale for the identified operator training simulation, Processorₙᵤₘ≧2; (Constraint 3)
where the time scale T_{scale} specifies acceleration of 32 times or more, but less than 64 times the default time scale for the identified operator training simulation, Processorₙᵤₘ≧4; (Constraint 4)
where the time scale T_{scale} specifies acceleration of 64 times or more over the default time scale for the identified operator training simulation, Processorₙᵤₘ≧8; (Constraint 5)
where the division of basic cycle value BasCycleᵥₐₗ is 1, Processorₙᵤₘ≧2; (Constraint 6)
where the division of basic cycle value BasCycleᵥₐₗ is 2, Processorₙᵤₘ≧4; (Constraint 7)
where the division of basic cycle value BasCycleᵥₐₗ is 4, Processorₙᵤₘ≧8; (Constraint 8).

5. The method as claimed in claim 4, wherein at least one processor within the first physical host platform selected for instantiation of the master VM has a clock speed greater than or equal to 2.0 GHz.

6. The method as claimed in claim 1, wherein the either or both of the second and third physical host platforms comprise one or more of:
a processor having a clock speed greater than or equal to 2.0 GHZ;
at least 4 gigabytes of RAM; and
data storage capacity of at least 50 gigabytes.

7. A system for implementing a simulation based operator training system on a cloud based computing cluster, the system comprising:
an interface for receiving information identifying one or more parameters of an operator training simulation;
a repository of virtual machine (VM) images comprising at least a master VM image, an operator VM image and an instructor VM image;
a master VM instantiated on a first physical host platform selected from among a set of available cloud computing resources, wherein instantiation of the master VM is based on the master VM image;
an operator VM instantiated on a second physical host platform selected from among the set of available cloud computing resources, wherein instantiation of the operator VM is based on the operator VM image;
an instructor VM instantiated on a third physical host platform selected from among the set of available cloud computing resources, wherein instantiation of the instructor VM is based on the instructor VM image;
wherein the instantiated master VM and the instantiated operator VM are in network communication with each other, and the instantiated master VM and the instantiated instructor VM are in network communication with each other;
and wherein selection of the first physical host platform from among the set of available cloud computing resources is based on one or more of:
number of tags (Tₙᵤₘ) implemented within an identified operator training simulation;
a specified number of instances (Simₙᵤₘ) of the identified operator training simulation for parallel execution at the master VM;
a specified time scale (T_{scale}) for performance of the identified operator training simulation; and
a specified division of basic cycle (BasCycleᵥₐₗ) for performance of the identified operator training simulation.

8. The system as claimed in claim 7, wherein the first physical host platform comprises random-access memory (RAM) equal to or greater than Mem,, wherein Mem is determined based on constraint (1):
Mem_{RAM} (in gigabytes)=4+[CEIL(Tₙᵤₘ/10,000)+CEIL(Tₙᵤₘ/10,000) MOD 2)]×Simₙᵤₘ (Constraint 1)
wherein CEIL is a function that increments a calculated real number to the smallest integer that is not less than the calculated real number;
and wherein MOD is a function that returns a remainder after Euclidean division of one number by another number.

9. The system as claimed in claim 7, wherein the first physical host platform comprises data storage capacity equal to or greater than Memₛₜₒᵣₑ, wherein Mem_{store is} determined based on constraint (2):
Memₛₜₒᵣₑ (in gigabytes)=50+[CEIL(Tₙᵤₘ/10,000)]×20 (Constraint 2)
wherein CEIL is a function that increments a calculated real number to the smallest integer that is not less than the calculated real number.

10. The system as claimed in claim 7, wherein the first physical host platform comprises a number of processors equal to or greater than Processorₙᵤₘ, wherein Processorₙᵤₘ, is determined based on one or more of constraints (3) to (8):
where the time scale T_{scale} specifies acceleration of less than 32 times a default time scale for the identified operator training simulation, Processorₙᵤₘ≧2; (Constraint 3)
where the time scale T_{scale} specifies acceleration of 32 times or more, but less than 64 times the default time scale for the identified operator training simulation, Processorₙᵤₘ≧4; (Constraint 4)
where the time scale T_{scale} specifies acceleration of 64 times or more over the default time scale for the identified operator training simulation, Processorₙᵤₘ≧8; (Constraint 5)
where the division of basic cycle value BasCycleᵥₐₗ is 1, Processorₙᵤₘ≧2; (Constraint 6)
where the division of basic cycle value BasCycleᵥₐₗ is 2, Processorₙᵤₘ≧4; (Constraint 7)
where the division of basic cycle value BasCycleᵥₐₗ is 4, Processorₙᵤₘ≧8; (Constraint 8).

11. The system as claimed in claim 10, wherein at least one processor within the first physical host platform has a clock speed greater than or equal to 2.0 GHz.

12. The system as claimed in claim 7, wherein either or both of the second and third physical host platforms comprises one or more of:
a processor having a clock speed greater than or equal to 2.0 GHZ;
at least 4 gigabytes of RAM; and
data storage capacity of at least 50 gigabytes.

13. A computer program product for implementing a simulation based operator training system on a cloud based computing cluster, comprising a non-transitory computer usable medium having a computer readable program code embodied therein, the computer readable program code comprising instructions for:
receiving information identifying one or more parameters of an operator training simulation;
retrieving virtual machine (VM) images corresponding to each of a master VM, an operator VM and an instructor VM;
selecting from among a set of available cloud computing resources:
a first physical host platform for instantiation of a master VM;
a second physical host platform for instantiation of an operator VM; and
a third physical host platform for instantiation of an instructor VM;
instantiating:
at the first physical host platform, a master VM based on a retrieved master VM image;
at the second physical host platform, an operator VM based on a retrieved operator VM image; and
at the third physical host platform, an instructor VM based on a retrieved instructor VM image; and
configuring network connections between the instantiated master VM, operator VM and instructor VM;
wherein selection of the first physical host platform from among the set of available cloud computing resources is based on one or more of:
number of tags (Tₙᵤₘ) implemented within an identified operator training simulation;
a specified number of instances (Simₙᵤₘ) of the identified operator training simulation for parallel execution at the master VM;
a specified time scale (T_{scale}) for performance of the identified operator training simulation; and
a specified division of basic cycle (BasCycleᵥₐₗ) for performance of the identified operator training simulation.
